(19) United States
(12) Patent Application Publication
(10) Pub. No.: US 2024/0145934 A1
(43) Pub. Date: May 2, 2024

(54) ANTENNA DEVICE

(71) Applicant: Panasonic Intellectual Property Management Co., Ltd., Osaka (JP)

(72) Inventor: Hironori KIKUCHI, Miyagi (JP)

(21) Appl. No.: 17/769,298

(22) PCT Filed: Oct. 9, 2020
(86) PCT No.: PCT/JP2020/038227

§ 371 Date: Apr. 14, 2022

(30) Foreign Application Priority Data
Oct. 21, 2019 (JP) 2019-191812

(51) Int. Cl. H01Q 15/16; H01Q 21/08; H01Q 21/28

(52) U.S. Cl. CPC H01Q 15/16; H01Q 21/08; H01Q 21/28

(57) ABSTRACT

This antenna device comprises: an array antenna having a plurality of antenna elements arranged in a certain direction; and a reflective mirror provided at a position spaced a predetermined distance in the direction from one of the antenna elements positioned on both ends among the plurality of antenna elements.

### TECHNICAL FIELD

The present disclosure relates to an antenna apparatus.

### BACKGROUND ART

In the 5th generation (5G) mobile communication system, a radiation power occupancy rate in a spherical direction is newly added as an evaluation index for antenna and radio communication performance, and the standard value has been discussed in the 3rd Generation Partnership Project (3GPP). The introduction of the evaluation index increases the importance of area ratio of radiation power reaching a predetermined characteristic when a beam of an antenna is scanned, that is, characteristics of spherical coverage.

Patent Literature (hereinafter, referred to as “PTL”) 1 discloses a configuration in which spherical coverage is improved by a plurality of types of antenna elements arranged around user equipment.

PTL 2 discloses an exemplary configuration in which a reflector is provided for an array antenna powered with phase shifted, and the antenna directivity is radiated to the horizontal direction with respect to the antenna board.

### CITATION LIST

### Patent Literature

PTL 1
Japanese Utility Model Registration No. 3212787
PTL 2
Japanese Patent Application Laid-Open No. H02-179103

### SUMMARY OF INVENTION

### Technical Problem

The configuration of PTL 1 requires an arrangement of a plurality of types of antenna elements and a complicated power supply configuration, and thus there is room for consideration on the cost and the mounting area. The configuration of PTL 2 is not effective for enhancing the spherical coverage because the radiation direction is limited to the direction of the opening surface of the reflector.

One non-limiting and exemplary embodiment facilitates providing a technique which can expand a directivity control range of an array antenna with a simple configuration and enhance characteristics of spherical coverage.

### Solution to Problem

An antenna apparatus according to the present disclosure includes: an array antenna including a plurality of antenna elements arranged along a certain direction; and a reflector provided at a position spaced from one of antenna elements positioned at both ends among the plurality of the antenna elements, by a predetermined distance along the certain direction.

It should be noted that general or specific embodiments may be implemented as a system, an apparatus, a method, an integrated circuit, a computer program, a storage medium, or any selective combination thereof.

### Advantageous Effects of Invention

According to the present disclosure, since a directivity control range of an array antenna can be expanded with a simple configuration, it is possible to enhance spherical coverage characteristics.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a perspective view of an exemplary configuration of an antenna apparatus according to Embodiment 1 of the present disclosure;

FIG. 2 is a perspective view of an exemplary operation of the antenna apparatus according to Embodiment 1 of the present disclosure;

FIG. 3 is a diagram illustrating an exemplary arrangement of a reflector according to Embodiment 1 of the present disclosure;

FIG. 4 is a diagram illustrating an exemplary radiation pattern of the antenna apparatus according to Embodiment 1 of the present disclosure when the feed phase difference is 0 degrees;

FIG. 5 is a diagram illustrating an exemplary radiation pattern of the antenna apparatus according to Embodiment 1 of the present disclosure when the feed phase difference is 150 degrees;

FIG. 6 is a perspective view of an exemplary configuration of an antenna apparatus according to Embodiment 2 of the present disclosure;

FIG. 7 is a perspective view of an exemplary configuration of an antenna apparatus according to Embodiment 3 of the present disclosure;

FIG. 8 is a perspective view of an exemplary configuration of an antenna apparatus according to Embodiment 4 of the present disclosure; and

FIG. 9 is a perspective view of an exemplary configuration of an antenna apparatus according to Embodiment 5 of the present disclosure.

### DESCRIPTION OF EMBODIMENTS

Hereinafter, embodiments of the present invention will be described in detail with reference to the drawings as appropriate. However, a detailed description more than necessary may be omitted, such as a detailed description of a well-known matter and a duplicate description for a substantially identical configuration, to avoid unnecessary redundancy of the following description and to facilitate understanding by a person skilled in the art.

It is to be noted that the accompanying drawings and the following description are provided to enable those skilled in the art to fully understand this disclosure, and are not intended to limit the claimed subject.

### Embodiment 1

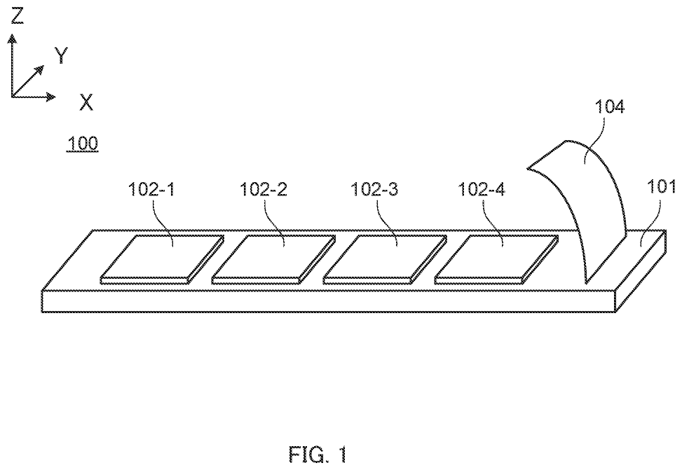

Embodiment 1 will be described with reference to FIG. 1 to FIG. 5.

[1-1. Configuration]

FIG. 1 is a perspective view of an exemplary configuration of an antenna apparatus according to Embodiment 1 of the present disclosure. Antenna apparatus 100 includes: a plurality of array antenna elements 102-k (for example, k=1, 2, 3, or 4; hereinafter, collectively referred to as “array antenna 102” in some cases) formed on a surface of single-layer or multi-layer dielectric board 101; a phase shifter (not shown) connected to each of the plurality of array antenna elements 102-k; and reflector 104 disposed perpendicularly or substantially perpendicularly to dielectric board 101. A GND plane (not shown) is formed on the back surface of dielectric board 101.

Each of array antenna elements 102-k may be, for example, a planar antenna element called a patch antenna element or a microstrip antenna element. Four square patch antenna elements 102-k are described in FIG. 1, but the number of array antenna elements is not limited to four and may be two or more.

[1-2. Operation and Effects]

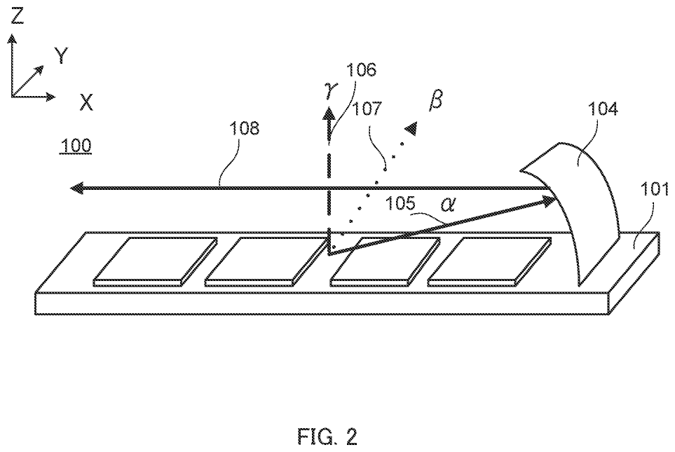

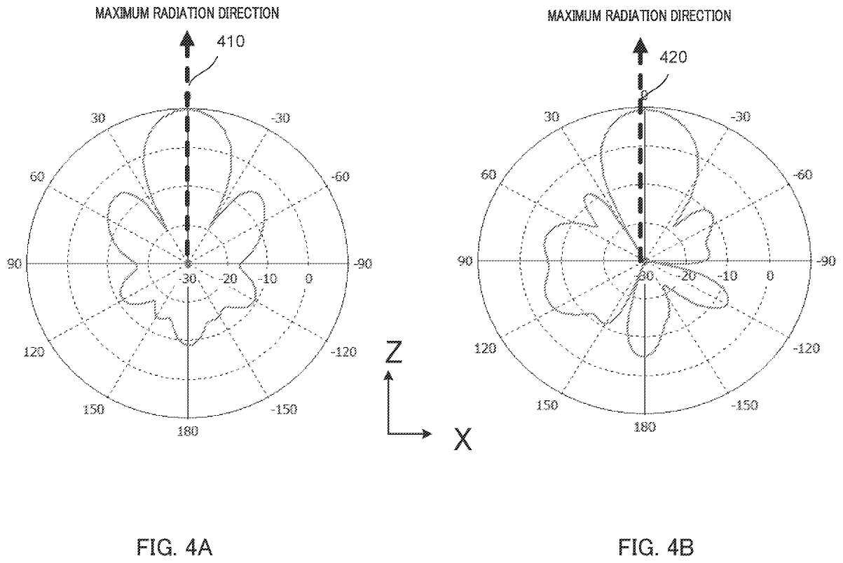

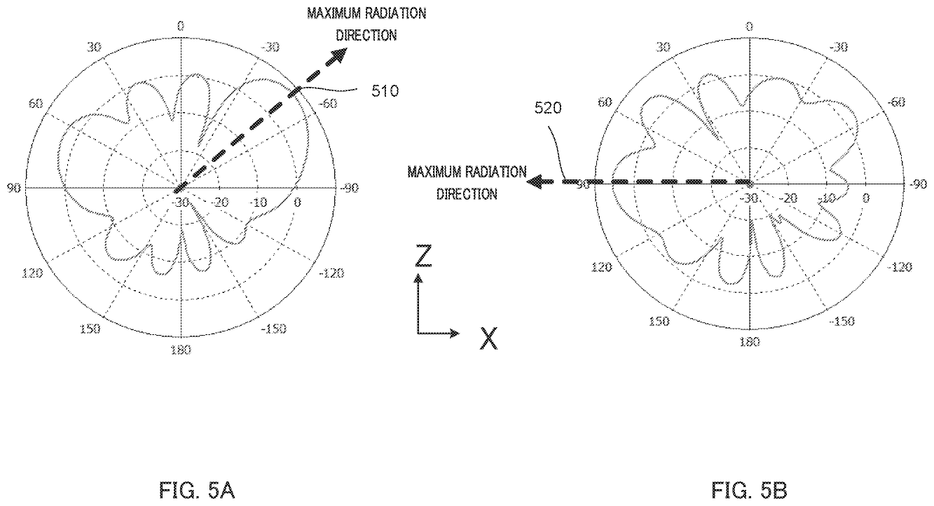

FIG. 2 is a perspective view of an exemplary operation of the antenna apparatus according to Embodiment 1 of the present disclosure. The operation example of antennal element 100 configured as described above will be described with reference to FIG. 2. Three radiation directions of the array antenna controlled by a feed phase difference generated by a phase shifter (not shown) are represented as radiation direction α (solid line) 105, radiation direction γ (broken line) 106, and radiation direction β (dotted line) 107. Radiation direction β 105 is a radiation direction when the feed phase difference is 150 degrees, radiation direction γ 106 is a radiation direction when the feed phase difference is 0 degrees, and radiation direction β 107 is a radiation direction when the feed phase difference is 90 degrees. As described later with reference to FIG. 4 and FIG. 5, radiation direction γ 106 corresponds to the largest feed phase difference valid for the beam tilt (incline) of array antenna 102.

Radiation direction γ 106 is, for example, a direction perpendicular or substantially perpendicular to the surface of dielectric board (hereinafter, also simply referred to as “board”) 101 (in other words, the direction along a positive direction of the Z-axis). The starting point of radiation direction γ 106 is, for example, the position on board 101 between array antenna element 102-2 and array antenna element 102-3, for example, the position corresponding to the center of the length (the X-axis direction) of array antenna 102. Note that the Y-axis corresponds to the width direction of dielectric board 101 (or array antenna 102).

When the feed phase difference between the plurality of array antenna elements 102-k is 150 degrees, the main radiation direction of array antenna 102 is obliquely upward with respect to the surface of board 101 (in other words, the direction shifted to the positive side of the X-axis with respect to radiation direction γ 106) as illustrated in FIG. 2.

As the feed phase difference is reduced to be less than 90 degrees, the main radiation direction of array antenna 102 is closer to the direction along the surface of board 101 (the positive direction of the X-axis). For example, when the feed phase difference is 150 degrees, the main radiation direction of array antenna 102 is the direction toward the curved surface of reflector 104 as illustrated in FIG. 2. A radio wave incident on reflector 104 is reflected, for example, to the direction indicated by solid arrow 108 (in other words, the direction along the surface of board 101 (the negative direction of the X-axis)).

Thus, changing (controlling) the feed phase difference between array antenna elements 102-k for controlling the main radiation direction of the radio wave to the direction incident on reflector 104 makes it possible to expand the directivity control range of array antenna 102, compared with the case where reflector 104 is not provided.

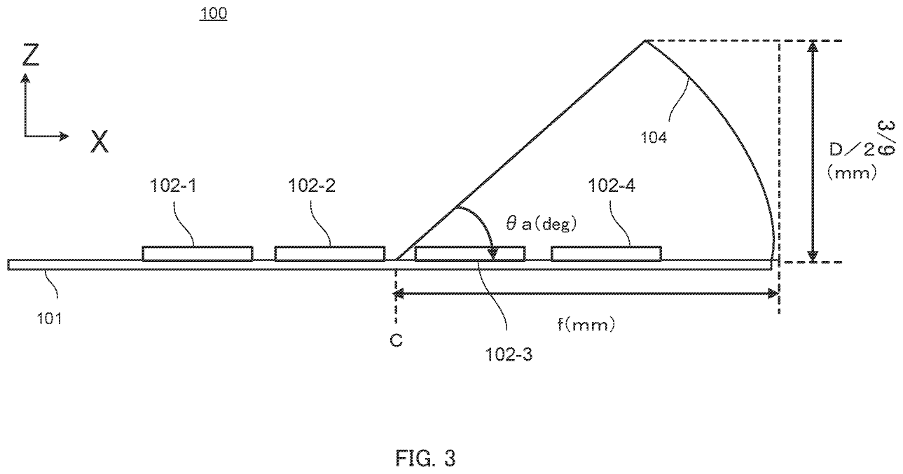

FIG. 3 is a diagram illustrating an exemplary arrangement of a reflector according to Embodiment 1 of the present disclosure. FIG. 3 illustrates the relation between antenna apparatus 100 and reflector 104 according to the present disclosure. In FIG. 3, θₐ indicates an opening angle (deg) of reflector 104, and D/2 (mm) is the height (the Z direction) of reflector 104. Here, D indicates the opening diameter of reflector 104, and f indicates the focal length (mm) of reflector 104. The letter “C” indicates the center position of array antenna 102 in the longitudinal direction, and is on the center line of the side where array antenna elements 102-2 and 102-3 face each other. In this example, focal length f is the length from center C of array antenna 102 in the longitudinal direction to the position of reflector 104 on dielectric board 101.

In antenna apparatus 100 with reflector 104 as illustrated in FIG. 3, controlling the feed phase to antenna apparatus 100 by a phase shifter (not shown) can expand the maximum radiation direction to the direction where a directivity control range of array antenna 102 is along the surface of board 101, and thus the spherical coverage of the antenna apparatus can be enhanced.

In other words, height D/2 (mm) of reflector 104 is designed to correspond to the largest opening angle, a, controllable by antenna apparatus 100, using the feed phase of the phase shifter. Thus, when the phase difference more than the feed phase difference of 90 degrees for the maximum radiation direction as illustrated in FIG. 5 (a) to be approximately −50 degrees is added (for example, when θₐ is between −50 and −90 degrees), a radio wave is reflected on reflector 104 and radiated to the horizontal direction of the opposite side (the side of +90 degrees); therefore, the maximum radiation direction in FIG. 5 (a) can be even closer to −90 degrees and thus the spherical coverage can be enhanced.

The shape of the reflecting surface of reflector 104 is, for example, a parabolic shape, but may be another curved shape. In other words, the shape of the reflecting surface may be any shape as long as the shape can change the direction (incident direction) of the radio wave incident obliquely with respect to the horizontal plane to the direction (emitting direction) along the horizontal plane by reflection.

Reflector 104 may be disposed at a predetermined distance in the vicinity of one of two ends of array antenna 102 in the longitudinal direction on dielectric board 101. Since height D/2 of reflector 104 can be lower as reflector 104 is closer to array antenna 102, it is preferable to place reflector 104 as close as possible to array antenna 102. Meanwhile, it is on condition that reflector 104 not cover center C of array antenna when viewed from the Z direction, that is, the opening angle of reflector 104 be less than 90 degrees.

FIGS. 4A and 4B are each a diagram illustrating an exemplary radiation pattern of the antenna apparatus according to Embodiment 1 of the present disclosure when the feed phase difference is 0 degrees. In FIGS. 4A and 4B, compared with FIG. 3, −90 degrees is a positive direction of the X-axis, +90 degrees is a negative direction of the X-axis, 0 degrees is a positive direction of the Z-axis, and 180 degrees is a negative direction of the Z-axis.

FIG. 4A illustrates an exemplary radiation pattern at a feed phase difference of 0 degrees in a conventional antenna apparatus without a reflector, and FIG. 4B illustrates an exemplary radiation pattern at a feed phase difference of 0 degrees in antenna apparatus 100 with reflector 104 according to Embodiment 1 of the present disclosure. In the conventional antenna apparatus without a reflector as described in FIG. 4A, maximum radiation direction 410 is the direction of 0 degrees when the feed phase difference is 0 degrees, while in antenna apparatus 100 with reflector 104 as described in FIG. 4B, maximum radiation direction 420 is the direction of 0 degrees when the feed phase difference is 0 degrees, which is the same as the antenna apparatus without reflector 104.

FIGS. 5A and 5B are each a diagram illustrating an exemplary radiation pattern of the antenna apparatus according to Embodiment 1 of the present disclosure when the feed phase difference is 150 degrees. In FIGS. 5A and 5B, compared with FIG. 3, −90 degrees is a positive direction of the X-axis, +90 degrees is a negative direction of the X-axis, 0 degrees is a positive direction of the Z-axis, and 180 degrees is a negative direction of the Z-axis.

FIG. 5A illustrates an exemplary radiation pattern at a feed phase difference of 150 degrees in a conventional antenna apparatus without a reflector, and FIG. 5B illustrates an exemplary radiation pattern at a feed phase difference of 150 degrees in antenna apparatus 100 with reflector 104 according to Embodiment 1 of the present disclosure. In the conventional antenna apparatus without a reflector as described in FIG. 5A, maximum radiation direction 510 is the direction of approximately −50 degrees when the feed phase difference is 150 degrees. In antenna apparatus 100 with reflector 104 as described in FIG. 5B, on the other hand, maximum radiation direction 520 is the direction of +90 degrees when the feed phase difference is 150 degrees, which is greatly different from the maximum radiation direction of −50 degrees in the antenna apparatus without reflector 104.

The radiation pattern of antenna apparatus 100 with reflector 104 when the feed phase difference is 150 degrees as described in FIG. 5B is close to a circular shape compared to the radiation pattern of the antenna apparatus without reflector 104 when the feed phase difference is 150 degrees as described in FIG. 5A. In addition, the radiation pattern of antenna apparatus 100 with reflector 104 when the feed phase difference is 0 degrees as described in FIG. 4B is close to a circular shape compared to the radiation pattern of the antenna apparatus without reflector 104 when the feed phase difference is 0 degrees as described in FIG. 4A.

Thus, in antenna apparatus 100 with reflector 104 according to the present disclosure, the radiation pattern is close to a circular shape and the spherical coverage of antenna apparatus 100 is enhanced when the feed phase difference is 0 degrees and 150 degrees, compared to the antenna apparatus without reflector 104.

### Embodiments 2 and 3

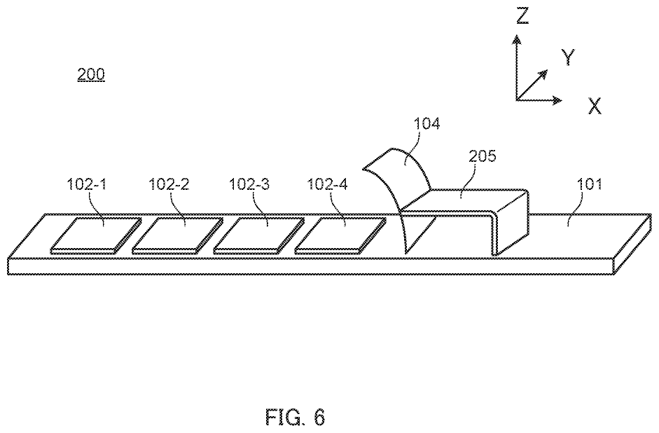

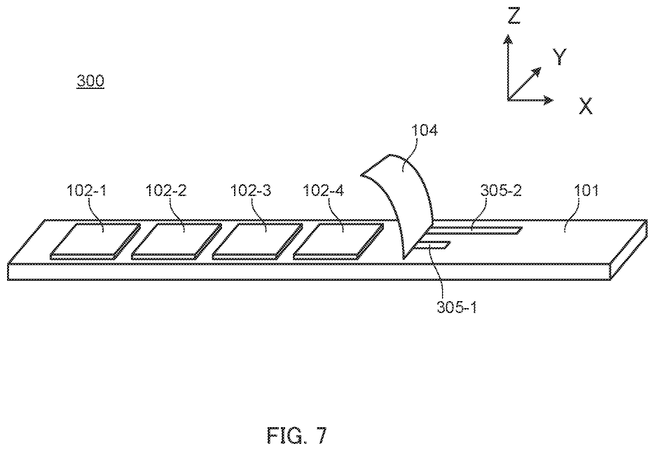

Embodiments 2 and 3 will be described with reference to FIGS. 6 and 7. FIG. 6 is a perspective view of an exemplary configuration of an antenna apparatus according to Embodiment 2 of the present disclosure, and FIG. 7 is a perspective view of an exemplary configuration of an antenna apparatus according to Embodiment 3 of the present disclosure.

Antenna apparatus 200 is a configuration in which reflector 104 in antenna apparatus 100 is shared with a portion of cellular antenna 205. The difference between antenna apparatus 200 in FIG. 6 and antenna apparatus 300 in FIG. 7 is a difference in shape between cellular antenna 205 and cellular antenna 305. Cellular antenna 205 illustrated in FIG. 6 has a three-dimensional shape with a letter “L” when viewed from the Y-direction. One side of cellular antenna 205 supports reflector 104, and another side of cellular antenna 205 is mounted on dielectric board 101 (Cellular antenna 205 supports reflector 104 at one side of cellular antenna 205 and is mounted on dielectric board 101 at another side thereof). Whereas, cellular antenna 305 illustrated in FIG. 7 includes two cellular antenna components 305-1 and 305-2, which are formed planarly on dielectric board 101 and integrally or in contact with reflector 104.

Configuring reflector 104 and a cellular antenna integrally or in contact with each other by such a configuration of cellular antenna 205 or 305 requires no dedicated part for supporting reflector 104. Accordingly, antenna apparatuses 200 and 300 which enhance the characteristics of spherical coverage can be formed at low costs or small in size.

Such a cellular antenna may be an antenna for applications other than LTE, such as wireless Local Area Network (LAN), Global Positioning System (GPS) or Bluetooth (registered trademark).

### Embodiment 4

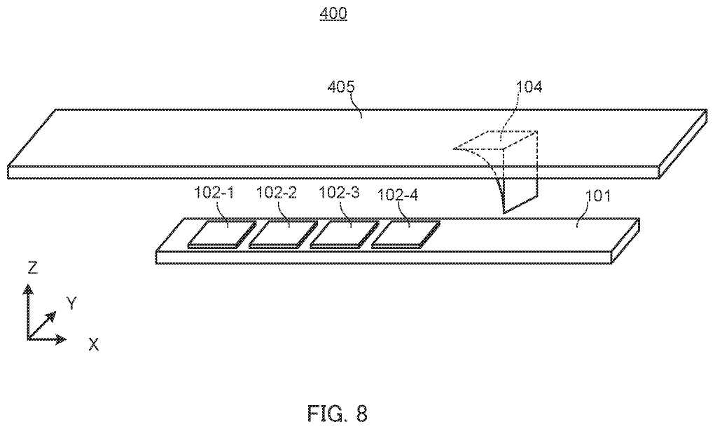

Embodiment 4 will be described with reference to FIG. 8. FIG. 8 is a perspective view of an exemplary configuration of an antenna apparatus according to Embodiment 4 of the present disclosure. A part of a housing (hereinafter, referred to as “housing part”) 405 is, for example, apart forming a portion of a housing of a portable radio terminal. Antenna apparatus 400 has a configuration in which reflector 104 in antenna apparatus 100 is shared with housing part 405. In the example illustrated in FIG. 8, reflector 104 is disposed on a surface of housing part 405. Reflector 104 may be molded integrally with housing part 405, or reflector 104 and housing part 405 may be each molded as separate parts and then reflector 104 may be placed on housing part 405. In such a configuration, housing part 405 is shared as a support part for reflector 104, and thus no dedicated support part for reflector 104 is required. Accordingly, antenna apparatus 400 that enhances the characteristics of spherical coverage can be formed at low costs or small in size.

Note that a cellular antenna may be disposed on any surface of housing part 405, and may be integrated with reflector 104 as illustrated in FIGS. 6 and 7.

### Embodiment 5

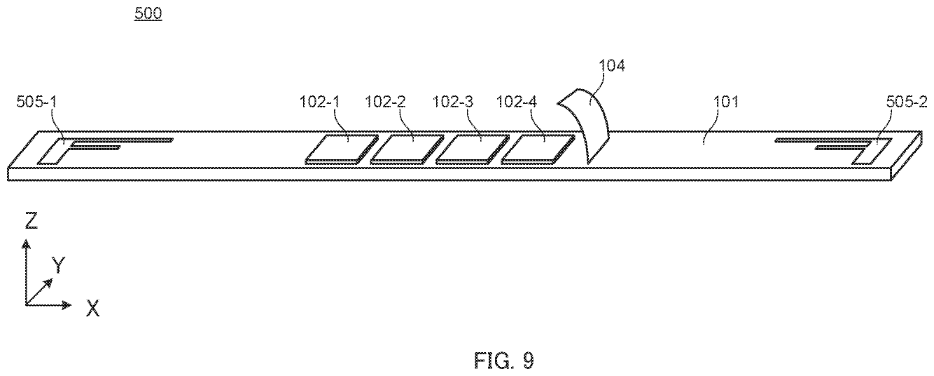

FIG. 9 is a perspective view of an exemplary configuration of an antenna apparatus according to Embodiment 5 of the present disclosure. Antenna apparatus 500 in FIG. 9 includes dielectric board 101, array antenna 102, and reflector 104 described above, and further includes cellular antennas 505-1 and 505-2 useable in a radio communication such as long term evolution (LTE) or 5G.

Each of cellular antennas 505-1 and 505-2 may be configured by, for example, a monopole antenna or an inverted F antenna; and may be approximately a quarter length (λ/4) of wavelength k corresponding to the desired frequency to be received.

In this example, cellular antennas 505-1 and 505-2 are placed on both sides of dielectric board 101 such that array antenna 102 and reflector 104 are located between cellular antennas 505-1 and 505-2. However, one cellular antenna may be placed on one side of dielectric board 101 in the longitudinal direction. Further, as described with reference to FIGS. 6 and 7, reflector 104 may be molded integrally with cellular antenna 505-1 or 505-2.

With the antenna configuration illustrated in FIG. 9, a cellular antenna for 5G and a cellular antenna for 5G using not greater than 6 GHz band, 4G, or a system before 4G can be formed compactly on the same surface of dielectric board 101. Further, reflector 104 is included for the 5G antenna, so that characteristics of spherical coverage can be enhanced with this compact and low-cost configuration.

### Other Embodiments

As described above, Embodiments 1 to 5 have been described as examples of technique in the present disclosure. However, the technique in the present disclosure is not limited to the above, and can be applied to an embodiment where modification, substitution, addition, omission, or the like is performed. In addition, the component elements described in the above Embodiments 1 to 5 can be combined into a new embodiment.

The present disclosure can be realized by software, hardware, or software in cooperation with hardware.

Each functional block used in the description of the each embodiment described above can be partly or entirely realized by an LSI such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth, telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

<Summary of Present Disclosure>

An antenna apparatus according to the present disclosure includes: an array antenna including a plurality of antenna elements arranged along a certain direction; and a reflector provided at a position spaced from one of antenna elements positioned at both ends among the plurality of the antenna elements, by a predetermined distance along the certain direction.

In the antenna apparatus according to the present disclosure, the position of the reflector is a position where a radio wave is incident in a part of an angle range of a main radiation direction of the radio wave of the array antenna, the main radiation direction of the radio wave being a direction that changes corresponding to a feed phase difference between the plurality of antenna elements, and the reflector includes a reflection surface having a curved shape to convert a reflection direction when the main radiation direction is oblique with respect to a horizontal plane into a direction along the horizontal plane.

In the antenna apparatus according to the present disclosure, the reflector has an opening angle less than 90 degrees.

In the antenna apparatus according to the present disclosure, the reflector is formed with another antenna other than the array antenna or with a part of the other antenna.

In the antenna apparatus according to the present disclosure, the reflector is supported by a component forming the antenna apparatus.

In the antenna apparatus according to the present disclosure, at least one of the plurality of antenna elements is a planar antenna.

The disclosure of Japanese Patent Application No. 2019-191812, filed on Oct. 21, 2019, including the specification, drawings and abstract, is incorporated herein by reference in its entirety.

### INDUSTRIAL APPLICABILITY

The present disclosure is applicable to, for example, a device or terminal performing radio communication.

### REFERENCE SIGNS LIST

100, 200, 300, 400, 500 Antenna apparatus
101 Dielectric board
102 Array antenna
102-1 to 102-4 Array antenna element
104 Reflector
205 Cellular antenna
305-1, 305-2 Cellular antenna
405 Housing part
505-1, 505-2 Cellular antenna

1. An antenna apparatus, comprising:
an array antenna including a plurality of antenna elements arranged along a certain direction; and
a reflector provided at a position spaced from one of antenna elements positioned at both ends among the plurality of the antenna elements, by a predetermined distance along the certain direction.

2. The antenna apparatus according to claim 1, wherein
the position of the reflector is a position where a radio wave is incident in a part of an angle range of a main radiation direction of the radio wave of the array antenna, the main radiation direction of the radio wave being a direction that changes corresponding to a feed phase difference between the plurality of antenna elements, and
the reflector includes a reflection surface having a curved shape to convert a reflection direction when the main radiation direction is oblique with respect to a horizontal plane into a direction along the horizontal plane.

3. The antenna apparatus according to claim 1, wherein
the reflector has an opening angle less than 90 degrees.

4. The antenna apparatus according to claim 1, wherein
the reflector is formed with another antenna other than the array antenna or with a part of the other antenna.

5. The antenna apparatus according to claim 1, wherein
the reflector is supported by a component forming the antenna apparatus.

6. The antenna apparatus according to claim 1, wherein
at least one of the plurality of antenna elements is a planar antenna.
